(19) United States
(12) Patent Application Publication
(10) Pub. No.: US 2010/0272263 A1
(43) Pub. Date: Oct. 28, 2010

(54) DECRYPTING A NAS MESSAGE TRACED TO AN E-UTRAN

(75) Inventors: Yi-Zhi Yao, Beijing (CN); Steven Sobieszek, Addison, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/724,619

(22) Filed: Mar. 16, 2010

Related U.S. Application Data
(60) Provisional application No. 61/172,802, filed on Apr. 27, 2009.

(51) Int. Cl. H04K 1/00; H04M 1/66

(52) U.S. Cl. 380/270; 455/411

(57) ABSTRACT

A system and method for decrypting a Non-Access Stratum (NAS) message traced in an Evolved Universal Terrestrial Radio Access Network (E-UTRAN) includes a first step (700) of providing security information for a trace record for the NAS message, and a next step (702) includes decrypting the NAS message using the security information.

### FIELD OF THE INVENTION

The present invention relates generally to trace messaging in an Evolved Universal

Terrestrial Radio Access Network (E-UTRAN) and, in particular, to decrypting a Non-Access Stratum (NAS) message traced in an E-UTRAN.

### BACKGROUND OF THE INVENTION

In Universal Mobile Telecommunications System (UMTS) wireless communication networks, and Long Term Evolution (LTE) and 4G wireless telecommunication networks that include Evolved UMTS Terrestrial Radio Access Network (E-UTRAN), trace sessions are utilized for network analysis, troubleshooting, optimization, and other diagnostic functions.

Specifically, the E-UTRAN eNodeB (eNB) needs to record the NAS (Non-Access Stratum) message for a traced user equipment for some trace depth levels, e.g., for the maximum trace depth or for an operator specific trace depth. However, the NAS message is encrypted (e.g., for integrity protection and ciphering) before coming to the eNodeB, and the eNodeB is not aware of the security information (e.g., the input parameters for the integrity protection and ciphering algorithm) for decrypting the NAS message. As a result, the NAS messages in the trace record file are still encrypted and not understandable by the Trace Collection Entity (TCE), thus the Trace Collection Entity (TCE) can not use the message to make the trace analysis.

Therefore, it is desirable for operators to be able to understand the NAS messages traced by E-UTRAN, and in particular, it would be beneficial for operators to be able to 1) decrypt the NAS messages traced by E-UTRAN, or 2) get the decrypted NAS message from other network entities instead of E-UTRAN.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 is an example of wireless communication network elements used in accordance with the present invention;

FIG. 2 is a flow chart of trace signaling in accordance with a first embodiment of the present invention;

FIG. 3 is a flow chart of trace signaling in accordance with a second embodiment of the present invention;

FIG. 4 is a flow chart of trace signaling in accordance with a third embodiment of the present invention;

FIG. 5 is a flow chart of a trace decryption in accordance with the present invention;

FIG. 6 is a flow chart of trace signaling in accordance with a fourth embodiment of the present invention; and

FIG. 7 illustrates a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF EMBODIMENTS OF THE INVENTION

The present invention provides a technique for E-UTRAN operators to be able to decrypt a traced NAS messages or get the decrypted NAS message from other network entities, such as a Mobility Management Entity (MME), instead of E-UTRAN.

Specifically, the decryption information can be added to each trace record by another network entity (e.g., MME) outside of E-UTRAN such that a Trace Collection Entity can use it to decrypt the NAS messages of the trace record, or the NAS message can be decrypted and reported by another network entity (e.g., MME) outside of E-UTRAN to the Trace Collection Entity, as will be described below.

Before describing the detailed embodiments that are in accordance with the present invention, it should be observed that the embodiments reside primarily in combinations of method steps and apparatus components related to a trace session from the EM of E-UTRAN in LTE to an eNodeB, and trace information from the eNodeB to the MME, or a trace session from MME to eNodeB. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of a trace session in LTE described herein. The non-processor circuits may include, but are not limited to, a radio receiver, a radio transmitter, signal drivers, clock circuits, power source circuits, and user input devices. As such, these functions may be interpreted as steps of a method to perform the trace session in LTE. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

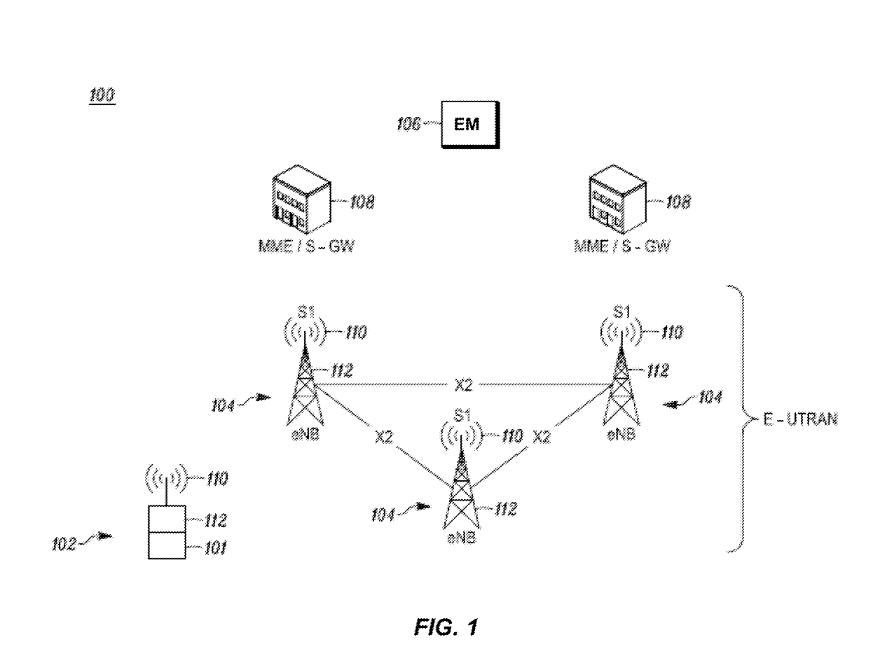

Turning to FIG. 1, a wireless communication network 100 is shown that includes the network elements used in connection with the embodiments described herein. The network 100 shown is described as an LTE-type network and includes E-UTRAN network although it is understood that the principles and embodiments described can be applied to other types of wireless communication networks. Network 100 is used by a subscriber whose identifier is residing in user equipment 102, which can be any type of mobile station including dual mode user equipment 102. User equipment 102 access the E-UTRAN network to communicate with other user equipment and other entities through an eNodeB 104 node. The eNodeB 104 nodes function as an access point into the wireless communication network and as a base station to communicate with other network entities or nodes within the network 100. As is understood, the E-UTRAN consists of eNodeBs 104 that are interconnected with each other by given X2 interfaces. The eNodeBs 104 host functions including radio resource management, radio bearer control, radio admission control, connection mobility and dynamic allocation of resources for use by a subscriber via user equipment 102 in both the uplink and downlink. The subscriber is associated with the user equipment 102 using an identifier 101.

The network 100 can also include an element manager 106. The element manager 106 specifies a package of management functions for network elements such as eNodeB 104. The element manager can be associated with eNodeB 104 or any combination of other network elements and can provide element management functions and sub-network management functions for the network elements. In addition, the network 100 can include a serving gateway (S-GW) or MME 108. The MME can provide scheduling and transmission of paging messages and broadcast messages that are provided to the eNodeBs 104 or other network elements.

As is understood by one of ordinary skill in the art, the user equipment 102 and the eNodeBs 104 include a standard transceiver 110 and processor 112. The transceiver transmits and receives messages and requests sent between the user equipment 102 and the eNodeBs over an S1 interface. The user equipment 102 and eNodeBs 104 including their respective transceivers 110 are operated using the processor 112.

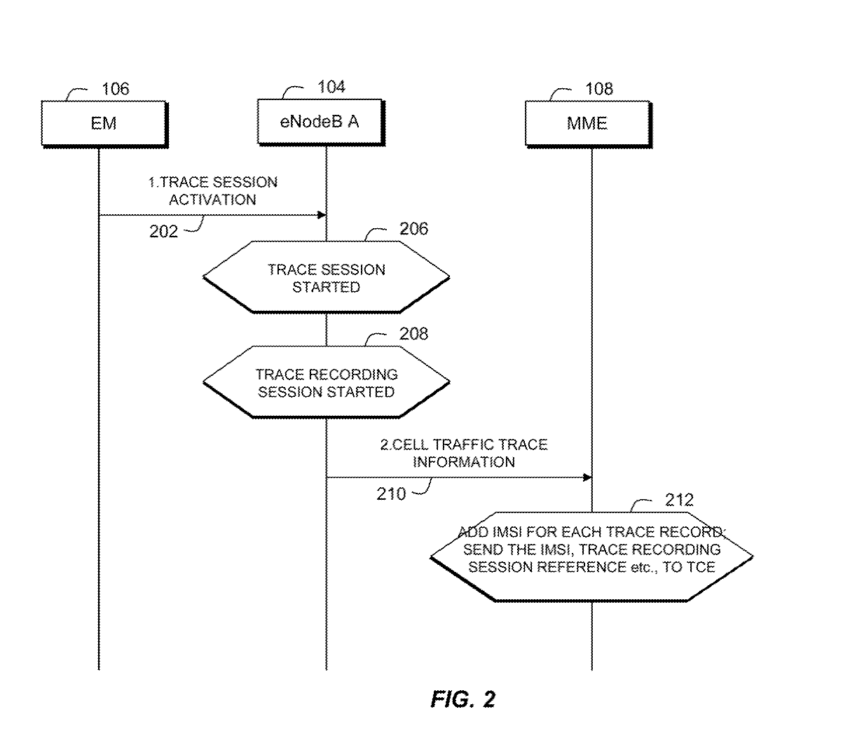

FIG. 2 illustrates a call flow chart for decrypting NAS messages of a cell traffic trace. A first step 202 activates a trace from the element manager 106 of an E-UTRAN. As seen, the element manager 106 activates 202 a trace session for an E-UTRAN cell to an eNodeB A 104. The element manager 106 activates the trace session by sending a trace session activation request with an identifier of an E-UTRAN cell that is to be traced to the eNodeB A 104. The element manager 106 also sends the trace control and configuration parameters in the trace session activation request. After receiving the trace session activation request, the eNodeB A 104 starts 206 the trace session and starts 208 the trace recording session for the subscriber. The eNodeB A 104 then forwards 210 the cell traffic trace information to the MME 108 that is associated with the eNodeB A 104.

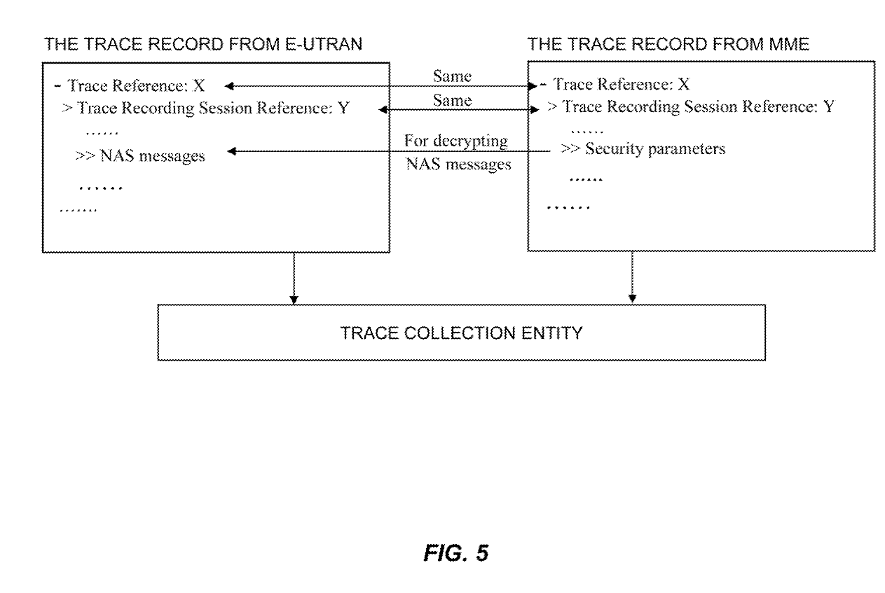

At this point, and in accordance with the present invention, the MME 108 adds 212 an International Mobile Subscriber Identifier or International Mobile Equipment Identifier and Software Version Number IMSI/IMEI(SV) of the user equipment for each trace record, including security information (e.g., input parameters for the integrity protection and ciphering algorithm) of NAS messages in each trace record (see FIG. 5). This total information including the security information can then be provided to a Trace Collection Entity (TCE) along with a trace recording session reference. As the trace record now contains the security information for the NAS messages in the trace record, the Trace Collection Entity (FIG. 5) will now be able to decrypt the NAS messages in the trace record using the added security information in order to obtain the necessary trace information.

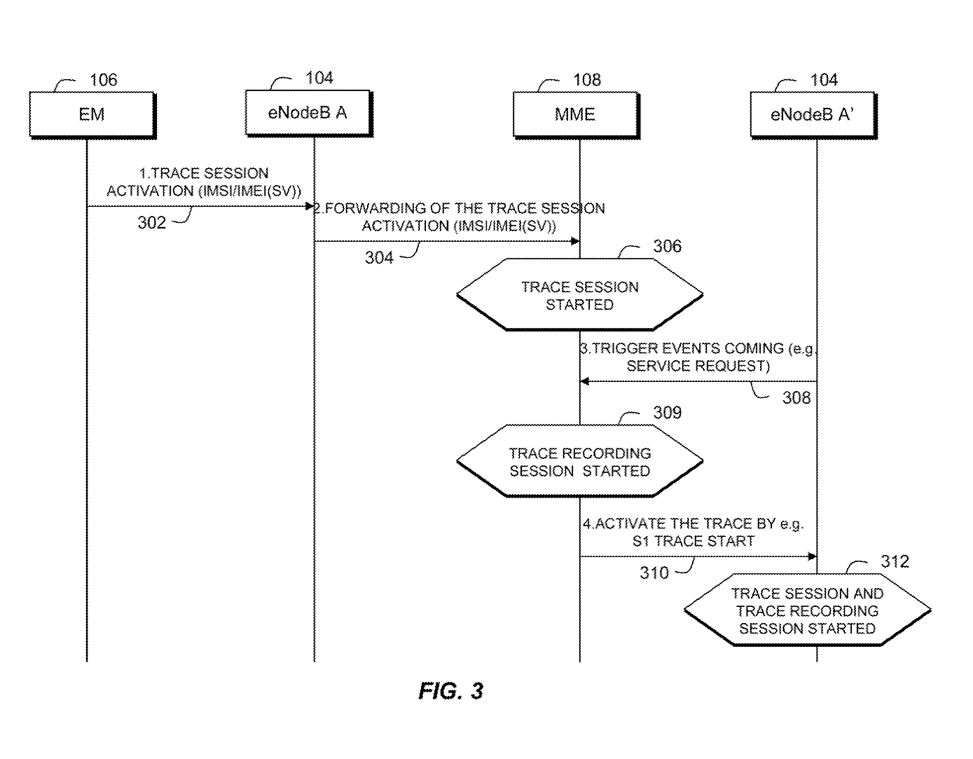

FIG. 3 illustrates a call flow chart for decrypting NAS messages of a management activated trace on an IMSI/IMEI(SV). A first step 302 activates a trace using IMSI/IMEI(SV) that is originated from the element manager 106 of an E-UTRAN. The IMSI/IMEI(SV) is an identifier 101 for a subscriber and is associated with a user equipment 102. As seen, the element manager 106 activates 302 a trace session using the IMSI/IMEI(SV) of a subscriber identifier 101 to user equipment 102 for which the trace session is needed to an eNodeB A 104. The element manager 106 activates the trace session by sending a trace session activation request with the IMSI/IMEI(SV) of the subscriber that is to be traced to the first eNodeB A 104. The element manager 106 also sends the trace control and configuration parameters along with the IMSI/IMEI(SV) in the trace session activation request. After receiving the trace session activation request, which includes the IMSI/IMEI(SV) for the subscriber, the first eNodeB A 104 forwards 304 the trace session activation request including the trace control and configuration parameters and the IMSI/IMEI(SV) of the subscriber to the MME 108 that is associated with the first eNodeB A 104. The eNodeB 104 forwards the trace session activation request via the Si interface between the eNodeB and the MME.

The MME 108 starts 306 the trace session for the subscriber associated with the IMSI/IMEI(SV) upon receipt of the activation. The trace session starts as a normal signaling based subscriber trace at the MME 108. As a part of the trace session, the subscriber can initiate an event such as a service request or other messages such as those found in 3GPP TS 32.422 and other sources. When a service request or similar message is received 308 from the eNodeB 104, which can be either the first eNodeB A or another eNodeB A′ 104, this event is considered a triggering event as a part of the trace session. It is understood that another eNodeB (A′) within the network 100 can trigger 308 the MME 108 to activate 310 the trace record by transferring the triggering events for the subscriber 101.

At this point, the MME 108 starts 309 the trace recording session for the subscriber. In accordance with the present invention, the MME 108 includes security information (e.g., input parameters for the integrity protection and ciphering algorithm) of NAS messages in each trace record (see FIG. 5). The MME 108 then sends 310 a message to the eNodeB A (or A′) 104 to activate the trace session associated with the IMSI/IMEI(SV). For example, the message can be an S1 message, e.g. S1 TRACE START message. Upon receipt of the trace activation request 310, e.g. S1 TRACE START message, the eNodeB A (or A′) 104 starts 312 the trace session and trace recording session for the IMSI/IMEI(SV) according to the trace control and configuration parameters. As the trace record now contains the security information for the NAS messages in the trace record, a Trace Collection Entity (FIG. 5) will now be able to decrypt the NAS messages in the trace record using the security information in order to obtain the necessary trace information.

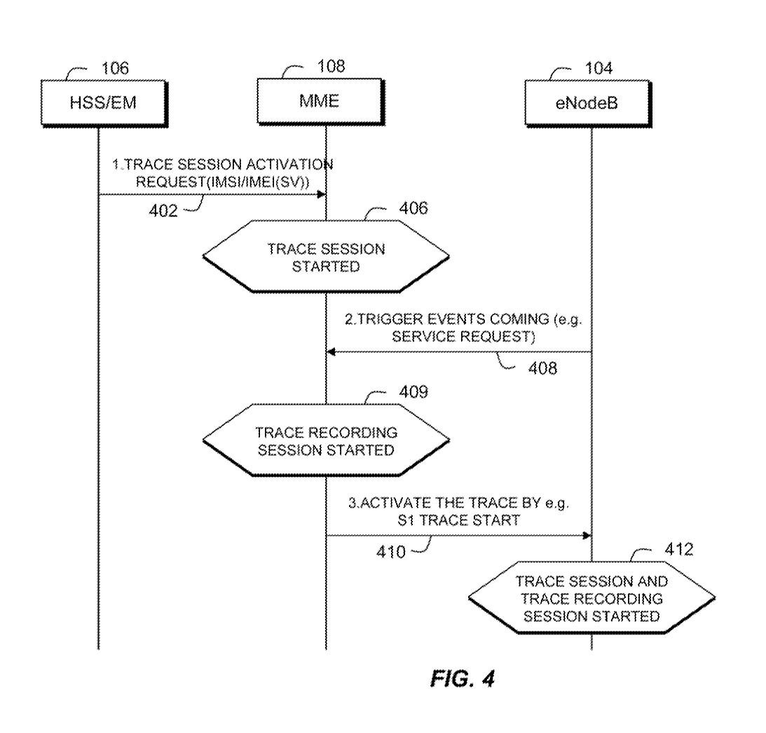

FIG. 4 illustrates a call flow chart for decrypting NAS messages of a signaling activated trace to E-UTRAN. A first step 402 activates a trace that is originated from the Home Subscriber Server (HSS) and/or element manager 106 of an E-UTRAN. As seen, the element manager 106 activates 402 a trace session to user equipment 102 for which the trace session is needed to an MME 108. The element manager 106 activates the trace session by sending a trace session activation request to the MME 108. The element manager 106 also sends the trace control and configuration parameters in the trace session activation request. After receiving the trace session activation request, the MME 108 starts 406 the trace session for the subscriber. The trace session starts as a normal signaling based subscriber trace at the MME 108. As a part of the trace session, the subscriber can initiate an event such as a service request or other messages such as those found in 3GPP TS 32.422 and other sources. When a service request or similar message is received 408 from the eNodeB 104, this event is considered a triggering event as a part of the trace session.

At this point, the MME 108 starts 409 the trace recording session for the subscriber. In accordance with the present invention, the MME 108 includes security information (e.g., input parameters for the integrity protection and ciphering algorithm) of NAS messages in each trace record (see FIG. 5). The MME 108 then sends 410 a message to the eNodeB 104 to activate the trace session. For example, the message can be an 51 message, e.g. S1 TRACE START message. Upon receipt of the trace activation request 410, e.g. S1 TRACE START message, the eNodeB 104 starts 412 the trace session and trace recording session according to the trace control and configuration parameters. As the trace record now contains the security information for the NAS messages in the trace record, a Trace Collection Entity (FIG. 5) will now be able to decrypt the NAS messages in the trace record using the security information in order to obtain the necessary trace information. In this scenario, the MME include only the security information in each Trace record. The Trace Collection Entity can then use the security information provided by MME to decrypt the NAS message recorded by E-UTRAN, by correlating the trace records from the MME and E-UTRAN using the same trace recording session reference. The MME may choose to not providing any parameters with constant value (like the “BEARER ID”), unless it is changed from the last reporting.

FIG. 5 demonstrates the trace record available to the TCE from both the MME and E-UTRAN. Both the MME and E-UTRAN contain the same Trace Reference (X) and Trace Recording Session Reference (Y), and in fact the TCE need only obtain this information from one or the other of the MME and E-UTRAN, instead of both.

E-UTRAN also includes the encrypted NAS messages in the trace record, while the MME provides the security (information) parameters for those corresponding NAS message, which the TCE can use to decrypt the NAS messages from E-UTRAN. In this way, the TCE is able to provide proper trace operation in an LTE system.

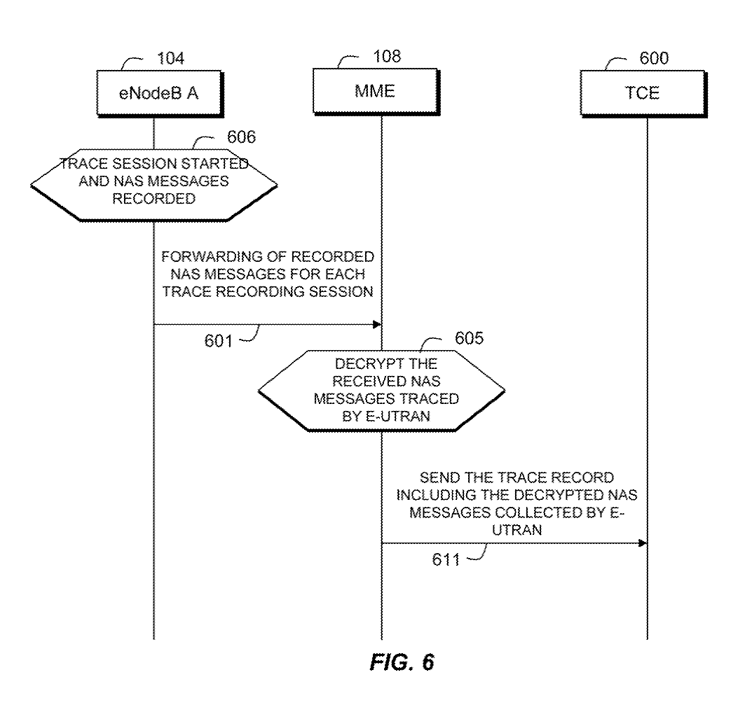

Referring to FIG. 6, in an alternative embodiment of the present invention, the MME does the actual decryption, and provides the already decrypted information to the TCE. In particular, an eNodeB 104 can start 606 a trace session for the subscriber and record NAS messages. The eNodeB 104 can then forward the recorded NAS messages for each trace recording session to the MME 108. At this point, and in accordance with the present invention, the MME 108 can decrypt 605 the received NAS messages traced by E-UTRAN (using the security information it has for encryption/decryption algorithm, e.g., the integrity protection and ciphering algorithm of NAS messages), and send 611 the trace record including the decrypted NAS messages collected by E-UTRAN directly to the TCE 600. The TCE can then process the already decrypted trace information in a normal manner, as is done for 3GPP GSM/UMTS.

A preferred embodiment of the invention includes security (information) parameters in a Trace record for decrypting the NAS messages traced by E-UTRAN, as is represented in the various forms of trace recording demonstrated in FIGS. 2 through 5. In particular, this embodiment adds the security parameters in Trace record file format for decrypting the NAS messages traced by E-UTRAN, and limits that these security parameters only need to be presented in the Trace record from MME, when there is the need to trace NAS messages by E-UTRAN (e.g., for the maximum depth or a vendor specific depth level). The reason for this embodiment is that the NAS (Non-Access Stratum) messages are traced by E-UTRAN for the traced user (IMSI/IMEI(SV)) for the maximum depth or a vendor specific depth level. However, the NAS message is encrypted and E-UTRAN is not aware of the security parameters to decrypt them. So when the NAS messages in the trace record file sent by E-UTRAN (or via EM) to the Trace Collection Entity, is still encrypted, these NAS messages can not be understood by the Trace Collection Entity. As the MME knows the security parameters for the encryption/decryption of each Traced NAS message, and all kinds of the Trace in E-UTRAN, the MME needs to get involved, so the MME is able to include the security parameters in each Trace record which is needed to get E-UTRAN to trace the NAS messages (e.g., for the maximum depth or vendor specific depth level), which then will be used by Trace Collection Entity to decrypt the corresponding NAS messages in the Trace record with same Trace Recording Session Reference received from E-UTRAN.

An alternative embodiment of the invention forwards the NAS messages by E-UTRAN to the MME for decryption, as represented in FIG. 6. In particular, this embodiment adds a mechanism to forward the traced NAS messages by an eNodeB to the MME, and the MME then decrypts and sends the decrypted messages to the Trace Collection Entity. The reason for this embodiment is that the NAS (Non-Access Stratum) messages are traced by E-UTRAN for the traced user (IMSI) for the maximum depth or a vendor specific depth level. However, the NAS message is encrypted and E-UTRAN is not aware of the security parameters to decrypt them. So if the the NAS messages in the trace record file sent by E-UTRAN (or via EM) is directly sent to the Trace Collection Entity, these encrypted NAS messages can not be understood by the Trace Collection Entity. As the MME knows the security parameters for the encryption/decryption of each Traced NAS message, so the MME can decrypt these NAS messages if the eNodeB forwards them to the MME, and the MME can and then forward the decrypted messages to Trace Collection Entity.Specifically, this embodiment incorporates a new E-UTRAN starting mechansim wherein if the NAS message is traced by E-UTRAN, the eNodeB shall forward these NAS messages to the MME by an S1 message (e.g., S1-Traced NAS messages) for decryption, in which the following attributes should be included: Trace Reference, Trace Recording Session Reference, MME UE S1AP ID, and NAS-PDU.

Another alternative embodiment of the invention adds a mechanism to request the MME to record the decrypted NAS messages by the eNodeB, and the MME then send the decrypted messages in Trace Record to the Trace Collection Entity. The reason for this embodiment is that the NAS (Non-Access Stratum) messages are traced by E-UTRAN in current standards (3GPP TS 32.423) for the maximum depth or a vendor specific depth level. However, the NAS message is encrypted and E-UTRAN is not aware of the security parameters to decrypt them. So if the the NAS messages in the trace record file sent by E-UTRAN (or via EM) is directly sent to the Trace Collection Entity, these encrypted NAS messages can not be understood by the Trace Collection Entity. As the MME can decrypt the NAS message, so if the MME can record the NAS messages which are required to be traced in E-UTRAN, as per the request from eNodeB, then the eNodeB does not need to record and report the encrypted NAS messages any more.

Specifically, this embodiment incorporates a new E-UTRAN starting mechansim wherein if the NAS messages need to be traced as per the Trace control and configuration parameters in the cell traffic Trace Session activation request from EM, the eNodeB will request the MME to record the NAS decrypted messages for the subscribers or equipments in the traced cells. The eNB can send by either a standalone S1 message (e.g., S1-Cell Trace NAS Record) to request MME to record the NAS messages for all of the subscribers or equipments in the traced cells, or individual S1 messages (e.g., S1-UE NAS Record) for each Trace Recording Session to request MME to record the NAS messages for each subscriber or equipment (the individual S1 message can be either a separate message or combined with another S1 message like the S1-Cell Traffic Trace Information in FIG. 2), whereafter the eNodeB will not record the NAS messages any more. And for E-UTRAN, the NAS message will be not recorded for any kinds of the Trace depth levels. This embodiment also incorporates a new E-UTRAN deactivation mechansim wherein the eNodeB shall request MME to stop recording the NAS decrypted messages for subscribers and equipments in those E-UTRAN Cells. The eNB can send this by either a standalone S1 message (e.g., S1-Cell Trace NAS Record Stop) to request MME to stop recording the NAS messages for all of the subscribers or user equipments in those E-UTRAN Cells, or individual S1 messages (e.g., S1-UE NAS Record Stop) for each Trace Recording Session to request MME to stop recording the NAS messages for each subscriber or equipment.

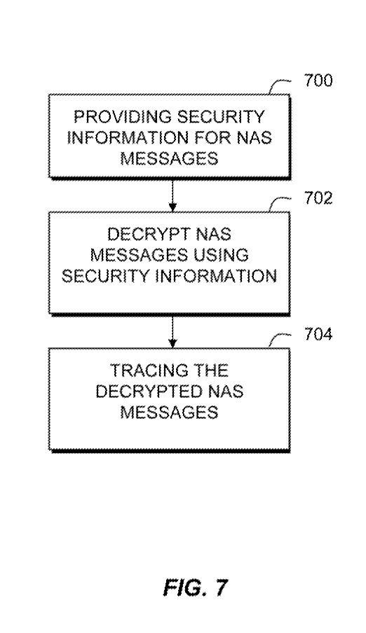

Referring to FIG. 7, the present invention also includes a method for decrypting a Non-Access Stratum (NAS) message traced in an Evolved Universal Terrestrial Radio Access Network (E-UTRAN) communication system.

The method includes a first step 700 of providing security information that includes input parameters for the trace record of the NAS message for decrypting (e.g., an integrity protection and ciphering algorithm of) the NAS message. Preferably, this is provided by a Mobility Management Entity. In one embodiment of the invention the input parameters are explicitly included along with the trace record. The alternative embodiments do not require the security parameters to be explicitly included in the trace record, as the MME will decrypt the NAS message and only include the decrypted NAS message in the trace record and sent it to Trace Collection Entity (TCE), and therefore the inputs parameters are only associated with and provided for the trace record.

This step 700 can be used in a trace record for a cell traffic trace, which would includes the substeps of: requesting a trace session activation; starting a trace session; starting a trace recording session; forwarding cell traffic trace information; and adding the IMSI for each trace record, including the security information of NAS messages in each trace record, and including a trace recording session reference.

Also, this step 700 can be used in a management activated trace from E-UTRAN, which would includes the substeps of: requesting a trace session activation using a subscriber user equipment identifier; forwarding a trace session activation request including the identifier; starting a trace session; receiving a triggering event to activate a trace record; starting a trace recording session (including the security information of NAS messages in each trace record); sending a message to activate a trace session; and starting the trace session and a trace recording session for the identifier.

Further, this step 700 can be used in a signaling activated trace, which would includes the substeps of: requesting a trace session activation; starting a trace session; receiving a triggering event to activate a trace record; starting a trace recording session (including the security information of NAS messages in each trace record); sending a message to activate a trace session; and starting the trace session and a trace recording session.

The method includes a next step 702 of decrypting the NAS message using the security information. Preferably, this is providing in a Trace Collection Entity, but could be providing in a Mobility Management Entity. In case of the step 702 is providing in a Mobility Management Entity, the step 700 could be done implicitly, i.e., the security information of NAS messages could not be present in each trace record.

An optional next step 704 includes tracing the decrypted NAS message. This includes the substeps of: a) requesting to record the decrypted NAS message; b) recording the decrypted NAS message into trace record; c) requesting to stop recording the NAS message; and d) stopping recording the NAS message. Preferably, the requesting to record and requesting to stop recording steps are performed in a E-UTRAN eNodeB, and the recording and stopping recording steps are performed in a Mobility Management Entity. This step can be used to provide cell traffic tracing.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for decrypting a Non-Access Stratum (NAS) message traced in an Evolved Universal Terrestrial Radio Access Network (E-UTRAN), the method comprising the steps of:
providing security information for a trace record of the NAS message; and
decrypting the NAS message using the security information.

2. The method of claim 1, wherein the security information includes input parameters for decrypting the NAS message.

3. The method of claim 1, wherein the decrypting step is performed in a Mobility Management Entity under the request from E-UTRAN.

4. The method of claim 1, wherein the providing step is performed in a Mobility Management Entity, and the decrypting step is performed in a Trace Collection Entity.

5. The method of claim 1, wherein the providing step includes adding the security information for a trace record for a cell traffic trace.

6. The method of claim 1, wherein the providing step includes adding the security information for a management activated trace from E-UTRAN.

7. The method of claim 1, wherein the providing step includes adding the security information for a signalling activated trace.

8. The method of claim 1, further comprising the step of tracing the decrypted NAS message, comprising the substeps of:
requesting to record the decrypted NAS message;
recording the decrypted NAS message into trace record;
requesting to stop recording the NAS message; and
stopping recording the NAS message;

9. The method of claim 8, wherein the requesting to record and requesting to stop recording steps are performed in an E-UTRAN eNodeB, and the recording and stopping recording steps are performed in a Mobility Management Entity.

10. The method of claim 8, wherein the tracing step includes cell traffic tracing.

11. A method for decrypting a Non-Access Stratum (NAS) message traced in an Evolved Universal Terrestrial Radio Access Network (E-UTRAN), the method comprising the steps of:
providing security information along with a trace record of the NAS message by a Mobility Management Entity; and
decrypting the NAS message using the security information in a Trace Collection Entity.

12. The method of claim 11, wherein the providing step includes the substeps of:
requesting a trace session activation;
starting a trace session;
starting a trace recording session;
forwarding cell traffic trace information; and
adding a user equipment identifier for each trace record, including the security information of NAS messages in each trace record, and including a trace recording session reference.

13. The method of claim 11, wherein the identifier of the adding step is an International Mobile Subscriber Identifier or International Mobile Equipment Identifier and Software Version Number IMSI/IMEI(SV).

14. The method of claim 11, wherein the providing step includes the substeps of:
requesting a trace session activation;
forwarding a trace session activation request including the user equipment identifier;
starting a trace session;
receiving a triggering event to activate a trace record;
starting a trace recording session including the security information of NAS messages in each trace record;
sending a message to activate a trace session; and
starting the trace session and a trace recording session for the identifier.

15. The method of claim 11, wherein the providing step includes the substeps of:
requesting a trace session activation;
starting a trace session;
receiving a triggering event to activate a trace record;
starting a trace recording session including the security information of NAS messages in each trace record;
sending a message to activate a trace session; and
starting the trace session and a trace recording session.

16. A system for decrypting a Non-Access Stratum (NAS) message traced in an Evolved Universal Terrestrial Radio Access Network (E-UTRAN), the system comprising:
a Mobility Management Entity operable to provide security information with a trace record of the NAS message; and
a Trace Collection Entity operable to decrypt the NAS message using the security information.
